(19) United States
(12) Patent Application Publication
(10) Pub. No.: US 2003/0126269 A1
(43) Pub. Date: Jul. 3, 2003

(54) System and method for automatically configuring a protocol line trace filter

(75) Inventor: Herbert Lyvirn Lacey III, Garner, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 09/683,750

(22) Filed: Feb. 11, 2002

Related U.S. Application Data
(60) Provisional application No. 60/343,205, filed on Dec. 31, 2001.

(51) Int. Cl. G06F 15/16

(52) U.S. Cl. 709/230

(57) ABSTRACT

A system and method is provided for reliably filtering out data frames from a line trace, wherein the frames include variable, vendor specific idle pattern bytes. Initially, a idle pattern buffer is filled with the default idle pattern. When the protocol identifies an actual received idle pattern, the content of the idle pattern buffer is replaced with the identified idle pattern. Subsequent receive buffers are compared to the idle pattern buffer, and only those received buffers that do not match (i.e. contain at least one bit different from the idle pattern buffer) are included within the line trace.

### CROSS REFERENCE TO RELATED APPLICATIONS

This application claims the benefit of U.S. provisional patent application Serial No. 60/343,205 filed Dec. 31, 2001, the disclosure of which is incorporated herein by reference.

### BACKGROUND OF THE INVENTION

The present invention relates generally to electronic communication systems, and in particular, to systems and methods for tracing the receipt of data transmitted over such systems.

With the increasing popularity of the Internet and other content-heavy electronic communication systems, there has been a substantial need for reliable and affordable high bandwidth mediums for facilitating data transmissions between service providers and their customers. In relation to the requirement that such mediums be affordable to consumers, it was determined that the most cost-effective manner for providing service to customers was by using infrastructure already present in most locations. Accordingly, over recent years, the two such mediums most widely meeting these requirements include the cable television (CATV) and the conventional copper wire telephone systems (plain old telephone system or POTS).

Relating specifically to the adaptation of POTS telephone lines to carry data at high-bandwidth or “broadband” data rates, a number of Digital Subscriber Line (DSL) standards and protocols have been proposed. DSL essentially operates by formatting signals using various Time Domain Equalization techniques to send packets over copper wire at high data rates. A substandard of conventional DSL is known as Asymmetric Digital Subscriber Line (ADSL) and is considered advantageous for its ability to provide very high data rates in the downstream (i.e., from service provider to the user) direction by sacrificing speed in the upstream direction. Consequently, end user costs are minimized by providing higher speeds in the most commonly used direction. Further, ADSL provides a system that applies signals over a single twisted wire pair that simultaneously supports (POTS) service as well as high-speed duplex (simultaneous two-way) digital data services.

Two of the proposed standards for ADSL are set forth by the International Telecommunications Union, Telecommunication Standardization Section (ITU-T). A first, conventional, ADSL standard is described in ITU-T Recommendation G.992.1 Asymmetric Digital Subscriber Line (ADSL) Transceivers. A second, more recently proposed standard is the G.992.2 or “G.lite” standard, further described in ITU-T Recommendation G.992.2—Splitterless Asymmetric Digital Subscriber Line (ADSL) Transceivers. The G.lite standard is a variant of the G.992.1 standard, with modifications directed primarily to work in a splitterless environment (i.e., without a splitter at the remote user end to separate the voice traffic from the digital data traffic).

FIG. 1 is a simplified block diagram of one embodiment of a typical architecture 100 for a G.992.2 splitterless ADSL system. A user's computer 102 is coupled to an ADSL modem 104 and to a conventional telephone line 106. Similarly, a conventional telephone 108 is also connected to line 106 for communication over voice band frequencies. Upon exiting the customer premises, line 106 relays information on the line to a telecom provider's central office 110. The central office 110 includes a DSL modem and necessary equipment to establish a link to, for example, the Internet or other electronic communication network. As described above, contrary to conventional ADSL systems, splitterless ADSL systems do not require the presence of a splitter at the customer's premises for splitting the digital and voice data prior to deliver to the customer's conventional telephones. As briefly described above, all DSL system operate in essentially the following manner. Initial digital data to be transmitted over the network is formed into a plurality of multiplexed data frames and encoded using special digital modems into analog signals which may be transmitted over conventional copper wires at data rates significantly higher than voice band traffic (e.g., ˜1.5 Mbps (megabits per second) for downstream traffic, 150 kbps (kilobits per second) for upstream traffic). The length and characteristics of wire run from a customer's remote transceiver to a central office transceiver may vary greatly from user to user and, consequently, the possible data rates for each user also vary. In addition, the physical channel (i.e., the wires themselves) over which the system communicates also vary over time due to, for example, temperature and humidity changes, fluctuating cross-talk interference sources, and, in splitterless configurations such as those found in G.lite ADSL systems, phones transitioning between on-hook and off-hook states. Consequently, analog DSL signals exists in a noisy, time varying environment. Accordingly, DSL systems use sophisticated training techniques as well as various forms of performance monitoring methodologies to ameliorate these factors.

Relating specifically to performance monitoring, in order to provide maximum performance, systems conforming with the ITU-T ADSL (i.e., G.992.1) and G.lite ADSL (i.e., G.992.2) standards provide an embedded operations channel (eoc) between the ADSL Transceiver Unit-Central Office (ATU-C) and the ADSL Transceiver Unit-Remote user (ATU-R) located at the customer premises. The eoc enables the ATU-C and ATU-R to send and receive specific commands and messages from each other related to in-service and out-of-service maintenance and for the retrieval of ATU-R status information and performance monitoring parameters. Specifically, the eoc protocol allows the ATU-C to invoke eoc commands and the ATU-R to respond to the commands.

The eoc protocol operates in a repetitive command and response mode. In particular, the ATU-C acts as the master and issues bi-directional eoc messages to the ATU-R. The ATU-R acts as slave and responds to the bi-directional messages issued by the ATU-C by echoing the message back to the ATU-C. Three identical properly-addressed consecutive messages must be received before an action is initiated whether at the ATU-C or the ATU-R. More specifically, eoc channel data is conventionally carried within a single byte or octet (8 bits) of data contained within the Mux (multiplexed) Data Frame referred to as the Sync Byte (SB). The eoc bits transported in the SB shall contain either eoc message bits or an idle pattern of bits indicating that no synchronization action is necessary. In accordance with the above standards, a properly formatted idle pattern includes the hexadecimal value of XX0011X0b in the downstream direction (i.e. from ATU-C to ATU-R) and 000011X0b in upstream, where X denotes a bit which may be selected at the discretion of an implementing vendor and may be used to provide additional functionalities to the eoc. For example, a vendor may use the undefined bits in the idle pattern to define proprietary features or otherwise extend the standard protocol in an unspecific manner.

In addition to the system maintenance and status monitoring functions included within the architecture of the implemented ADSL protocol, many system administrators also find it extremely useful to manually analyze their networks to investigate potential problems or system bottlenecks. One such method involves conducting line traces of incoming transmitted data frames. Basically, upon the receipt of a frame of data, the frame is inspected and a log or trace of the network traffic is updated with information regarding the received frame, such as its source, its intended destination, the type of data contained therein, etc. In this manner, the administrator may readily determine the quantity, distributions, etc. of various types of data frames.

On relatively small or simple networks, it may be practical to conduct a trace of each and every frame of data that is received by the system. However, in more complex systems, such a trace would prove entirely too cumbersome to use as a tool. Similarly, real-time systems require that protocol processing and other tasks be performed on received frames in real time. That is, a system processor must receive, identify, and process each frame in a predetermined period of time, on the order of a few milliseconds. Consequently, although network tracing is useful, the strict requirements of real-time processing simply to do not permit the system cycle times required for simultaneous real-time tracing of all received frames. Accordingly, trace filtering methodologies are often performed on the incoming frames, such that a trace is only maintained for frames passing established filter requirements. As one example, frames having a particular source address may be preliminarily filtered from the trace, thereby reducing the overall scope of the trace.

As set forth above, the SB of an ADSL data frame may include an idle pattern indicating that no synchronization action is necessary on the part of the ATU-R. Because sufficient CPU cycles required to examine each octet as well as additional time for trace purposes does not exist at this time, it is often desirable to filter out frames containing only these idle bytes from the trace, thereby reducing the scope of the trace and simultaneously freeing up cycle time potentially required for the actual processing of the data.

Unfortunately, the very nature of the idle pattern byte established in by the ITU-T renders reliable filtering of such frames extremely difficult by including vendor discretionary bits within the idle pattern. Because as many as three of the eight bits in the downstream idle pattern may be chosen at the issuing vendor's discretion, it has conventionally been impossible to reliably filter out frames containing only idle pattern bytes, without re-configuring the filter upon identification of the new vendor's pattern. Even if the receiving transceiver were to know the idle patterns for each vendor from which frames are received, the filtering step would require processor-cumbersome table searching prior to filtering out these frames. This process may eat up the very cycle time the act of filtering is meant to free.

Accordingly, there is a need in the art of electronic communication systems for an improved system and method for reliably filtering out variable pattern frames from a line trace.

### SUMMARY OF THE INVENTION

The present invention overcomes the problems noted above, and provides additional advantages, by providing a system and method for reliably filtering out data frames from a line trace, wherein the frames include variable, vendor specific idle pattern bytes. Initially, a idle pattern buffer is filled with the default idle pattern. When the protocol identifies an actual received idle pattern, the content of the idle pattern buffer is replaced with the identified idle pattern. Subsequent receive buffers are compared to the idle pattern buffer, and only those received buffers that do not match (i.e. contain at least one bit different from the idle pattern buffer) are included within the line trace. The content of the trace filter buffer are adjusted at the beginning of each session, providing dynamic adaptation to the idle pattern of different vendor implementations. Accordingly, line trace content is simplified, thereby improving analysis capabilities. Additionally, by reducing the number of foreground cycles required to perform real-time tracing, the present invention also frees up resources, thereby minimizing system failures.

### BRIEF DESCRIPTION OF THE DRAWINGS

FIG. 1 is a simplified block diagram of one embodiment of a typical architecture for a G.992.2 splitterless ADSL system.

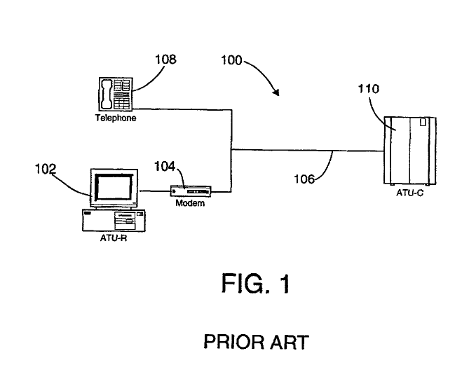

FIG. 2 is a flow diagram illustrating one embodiment of a method for initializing a default idle check buffer in accordance with the present invention.

FIG. 3 is a flow diagram illustrating one embodiment of a method for dynamically filtering idle pattern data frames from an incoming stream of data in accordance with the present invention.

### DETAILED DESCRIPTION OF THE INVENTION

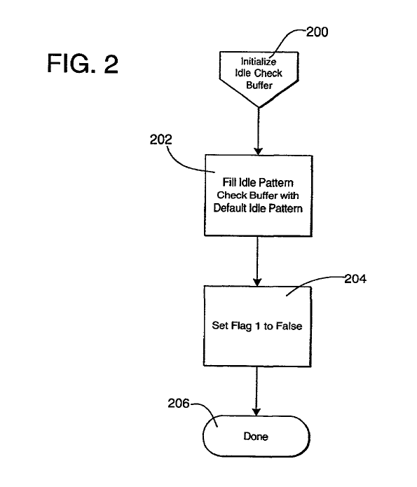

Referring now to the Figures and, in particular, to FIG. 2, there is shown a flow diagram illustrating a method for initiating the frame filtering system of the present invention. Initially, in step 200, an initialize idle pattern check buffer command is received. In one embodiment, this initialize command may be received on a periodic basis, such as at the beginning of each day, although any suitable time may be appropriate. Next, in step 202, the idle pattern check buffer is filled with the default idle pattern. In step 204, a flag F₁ is set to False, signifying that the default idle pattern is the current idle pattern. The initialization process is completed in step 206.

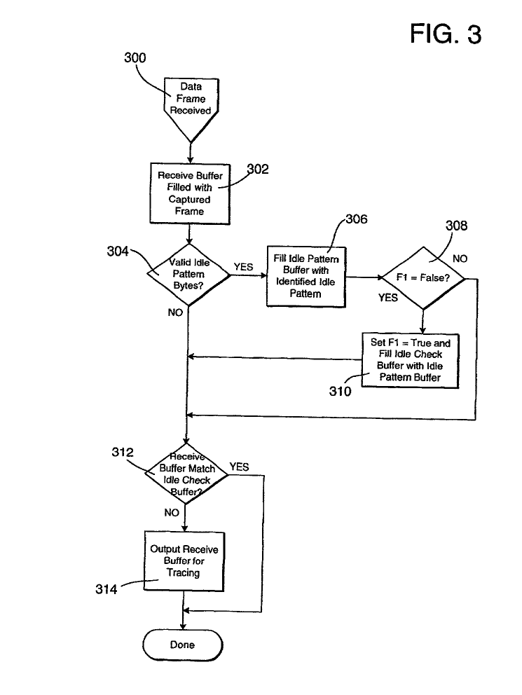

Continuing on to FIG. 3, there is shown a flow diagram illustrating one embodiment of a method for dynamically filtering idle pattern data frames from an incoming stream of data in accordance with the present invention. In step 300, a data frame is captured from the incoming data stream. In step 302, a receive buffer is filled with the received data frame. Next, in step 304, it is determined whether the receive buffer comprises only valid idle pattern bytes. If not, the process proceeds to step 312, described below. However, if a valid idle pattern is identified, an idle pattern buffer is filled with the identified idle pattern in step 306.

Next, in step 308, it is determined whether the flag F₁ set in step 204 above is equal to false, signifying that the current idle pattern remains the default idle pattern. If it is determined that F₁=False, F₁is set to True and the content of the idle pattern check buffer is replaced with the idle pattern buffer in step 310. If not, the process maintains the current idle pattern check buffer and proceeds to step 312, where it is determined whether the receive buffer matches the idle pattern check buffer. If the buffers match, an idle data frame is identified and the content is not output for tracing, however, if the buffers do not match, the frame is included in the trace in step 314.

This invention describes a method by which idle pattern octets may be filtered from a real-time protocol trace of a synchronous receive line, where the idle pattern is not known until first received. in the manner set forth above, the content of the trace filter buffer is adjusted at the beginning of each session, thereby providing dynamic adaptation to the idle pattern of different vendor implementations.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A method for automatically configuring a protocol line trace filter, comprising the steps of:
initializing an idle pattern check;
identifying an idle pattern within a received data frame;
filling an idle pattern check buffer with the idle pattern;
receiving a data frame into a receive buffer;
determining whether the receive buffer matches the idle pattern check buffer; and
outputting the receive buffer for tracing only if it is determined that the receive buffer does not match the idle pattern check buffer.

2. The method of claim 1, wherein the step of initializing an idle pattern check, further comprises the steps of:
filling the idle pattern check buffer with a default idle pattern; and
setting a flag to false.

3. The method of claim 2, further comprising the steps of:
filling an idle pattern buffer with the idle pattern;
determining whether the flag is set to false; and
filling the idle pattern check buffer with the idle pattern buffer and setting the flag to true if it is determined that the flag is set to false.

4. The method of claim 1, wherein the step of initializing the idle pattern check is performed periodically.

5. The method of claim 1, wherein the step of initializing the idle pattern check is performed daily.

6. A method for automatically configuring a protocol line trace filter, comprising the steps of:
filling the idle pattern check buffer with a default idle pattern;
setting a flag to false;
identifying an idle pattern within a received data frame;
filling an idle pattern buffer with the idle pattern;
determining whether the flag is set to false;
filling the idle pattern check buffer with the idle pattern buffer and setting the flag to true if it is determined that the flag is set to false.

7. The method of claim 6, further comprising the steps of:
receiving a data frame into a receive buffer;
determining whether the receive buffer matches the idle pattern check buffer; and
outputting the receive buffer for tracing only if it is determined that the receive buffer does not match the idle pattern check buffer.

8. A system for automatically configuring a protocol line trace filter, comprising:
means for initializing an idle pattern check;
means for identifying an idle pattern within a received data frame;
means for filling an idle pattern check buffer with the idle pattern;
means for receiving a data frame into a receive buffer;
means for determining whether the receive buffer matches the idle pattern check buffer; and
means for outputting the receive buffer for tracing only if it is determined that the receive buffer does not match the idle pattern check buffer.

9. The system of claim 8, wherein the means for initializing an idle pattern check, further comprise:
means for filling the idle pattern check buffer with a default idle pattern; and
means for setting a flag to false.

10. The system of claim 9, further comprising:
means for filling an idle pattern buffer with the idle pattern;
means for determining whether the flag is set to false; and
means for filling the idle pattern check buffer with the idle pattern buffer and setting the flag to true if it is determined that the flag is set to false.

11. The system of claim 8, further comprising means for periodically initializing the idle pattern check.

12. The method of claim 8, further comprising means for daily initializing the idle pattern check.

13. A system for automatically configuring a protocol line trace filter, comprising:
means for filling the idle pattern check buffer with a default idle pattern;
means for setting a flag to false;
means for identifying an idle pattern within a received data frame;
means for filling an idle pattern buffer with the idle pattern;
means for determining whether the flag is set to false;
means for filling the idle pattern check buffer with the idle pattern buffer and setting the flag to true if it is determined that the flag is set to false.

14. The system of claim 13, further comprising:
means for receiving a data frame into a receive buffer;
means for determining whether the receive buffer matches the idle pattern check buffer; and
means for outputting the receive buffer for tracing only if it is determined that the receive buffer does not match the idle pattern check buffer.

15. A computer readable medium incorporating instructions for automatically configuring a protocol line trace filter, the instructions comprising:
one or more instructions for initializing an idle pattern check;
one or more instructions for identifying an idle pattern within a received data frame;
one or more instructions for filling an idle pattern check buffer with the idle pattern;
one or more instructions for receiving a data frame into a receive buffer;
one or more instructions for determining whether the receive buffer matches the idle pattern check buffer; and
one or more instructions for outputting the receive buffer for tracing only if it is determined that the receive buffer does not match the idle pattern check buffer.

16. The computer readable medium of claim 15, wherein the one or more instructions for initializing an idle pattern check, further comprise:
one or more instructions for filling the idle pattern check buffer with a default idle pattern; and
one or more instructions for setting a flag to false.

17. The computer readable medium of claim 16, further comprising:
one or more instructions for filling an idle pattern buffer with the idle pattern;
one or more instructions for determining whether the flag is set to false; and
one or more instructions for filling the idle pattern check buffer with the idle pattern buffer and setting the flag to true if it is determined that the flag is set to false.

18. The computer readable medium of claim 15, wherein the one or more instructions for initializing the idle pattern check is performed periodically.

19. The computer readable medium of claim 15, wherein the one or more instructions for initializing the idle pattern check is performed daily.

20. A computer readable medium incorporating instructions for automatically configuring a protocol line trace filter, the instructions comprising:
one or more instructions for filling the idle pattern check buffer with a default idle pattern;
one or more instructions for setting a flag to false;
one or more instructions for identifying an idle pattern within a received data frame;
one or more instructions for filling an idle pattern buffer with the idle pattern;
one or more instructions for determining whether the flag is set to false;
one or more instructions for filling the idle pattern check buffer with the idle pattern buffer and setting the flag to true if it is determined that the flag is set to false.

21. The computer readable medium of claim 20, further comprising:
one or more instructions for receiving a data frame into a receive buffer;
one or more instructions for determining whether the receive buffer matches the idle pattern check buffer; and
one or more instructions for outputting the receive buffer for tracing only if it is determined that the receive buffer does not match the idle pattern check buffer.
